(19) United States
(12) Patent Application Publication
(10) Pub. No.: US 2024/0103171 A1
(43) Pub. Date: Mar. 28, 2024

(54) System, Method, and Computer Program Product for Globalizing Data Association Across Lidar Wedges

(71) Applicant: FORD GLOBAL TECHNOLOGIES, LLC, Dearborn, MI (US)

(72) Inventor: Kevin Wyffels, Livonia, MI (US)

(21) Appl. No.: 17/934,327

(22) Filed: Sep. 22, 2022

(51) Int. Cl. G01S 17/66; G01S 7/48; G01S 17/931

(52) U.S. Cl. CPC G01S 17/66; G01S 7/4802; G01S 17/931

(57) ABSTRACT

Provided are systems, methods, and computer program products for globalizing and optimizing data association detections of LiDAR sensor point cloud data by dividing detections across a global LiDAR sweep into detection wedges for perception and prediction of motion tracks detected in a scene surrounding the LiDAR.

### FIELD

This disclosure relates generally to globalizing and optimizing data association detections of light detection and ranging (LiDAR) sensor point cloud data by dividing detections across a global LiDAR sweep into detection wedges for perception and prediction of motion tracks detected in a scene surrounding the LiDAR.

### BACKGROUND

An autonomous vehicle (AV) is required to find an optimal route from the AV's current location to a specified destination (e.g., a goal position, etc.) in a geographic area of a road network. To travel autonomously requires the formation and navigation of a route to a destination or goal. Such routing may require evaluating any number of new object detections as a result of other movers or other objects in the roadway, as well as in-lane maneuvers such as tracking behind a mover, stopping when encountering a stationary object, or steering around to pass an object or mover in the roadway.

Creating a trajectory to handle maneuvers may involve the processing and storage of vast amounts of sensor data, such as detections of objects in the roadway, future maneuvers of actors, such as other movers (e.g., vehicles, bicyclists, motor cycles, scooters, etc.), or pedestrians in the path of the AV. Such processing and storage of large amounts of roadway data defines the roadway and accounts for all information concerning a state of the AV, including the dynamic capabilities of the AV in terms of managing the options available for maneuvering around objects in the roadway.

### SUMMARY

Accordingly, disclosed are improved computer-implemented systems, methods, and computer program products for globalizing data association across light detection and ranging (LiDAR) wedges.

Non-limiting embodiments or aspects are set forth in the following numbered clauses:

Clause 1: A computer-implemented method, comprising: determining, by one or more processors while detecting an active wedge in a scene of an environment surrounding an autonomous vehicle, one or more prior connected tracks in the scene based on a detection of a previous wedge in the scene; generating, by the one or more processors based on a local context in the detection of the active wedge, a conditionally connected track in the one or more prior connected tracks; generating, by the one or more processors, at least one region of influence comprising the conditionally connected track, wherein the at least one region of influence forms a union of the conditionally connected track and at least one of the one or more prior connected tracks; and globalizing, by the one or more processors, the scene over the active wedge and the previous wedge by assigning a confidence level to one or more detections in a localized approximation of a full optimal data association.

Clause 2: The computer-implemented method of clause 1, further comprising: obtaining the detection of the active wedge including point clouds from a partial revolution that are generated in each of the previous wedge and the active wedge by a rotating light detection and ranging (LiDAR) unit and accumulating the previous wedge and the active wedge to form a globalized LiDAR sweep.

Clause 3: The computer-implemented method of clauses 1 and 2, wherein the detection includes at least one of: a detection that lies entirely within the active wedge, a detection that starts in the previous wedge and extends across a boundary into the active wedge, a track completed in the active wedge which starts in the active wedge, or a track which extends beyond a boundary of the active wedge into a future wedge.

Clause 4: The computer-implemented method of clauses 1-3, wherein globalizing the scene over the active wedge and the previous wedge, comprises: matching the detection to one or more existing tracks which include at least one of a track that is previously assigned, a track that is previously uncertain, a track that is previously unassigned, or a new track, wherein: matching the detection to one or more existing tracks globalizes a local association of a track detected in the active wedge or the previous wedge for at least a time period of the scene; the confidence level is defined by associating one or more detections of the detection that match with tracks formed in the local context of the region of influence, tracks outside each region of influence, or tracks crossing into the future wedge; and globalizing the scene over the active wedge and the previous wedge causes the localized approximation of the full optimal data association with a result as if operations on the point clouds were performed on a full 360 degree sweep.

Clause 5: The computer-implemented method of clauses 1-4, wherein determining the one or more prior connected tracks, comprises: forecasting each track in the scene based on one or more previous detections up to a time of validity based on the active wedge; and generating a union of forecasted tracks that comprises a pairwise connection between one or more forecasted tracks, each pairwise connection determined to be within a pairwise threshold generated from a Euclidian distance of each data association gate for each of the forecasted tracks.

Clause 6: The computer-implemented method of clauses 1-5, further comprising: determining a previously connected edge to prune by removing all edges connecting to each track that is located within the active wedge of the scene that does not include any detections from the active wedge within its data association gate.

Clause 7: The computer-implemented method of clauses 1-6, wherein generating a conditionally connected track in the one or more prior connected tracks further comprises: determining a conditionally connected edge to add by connecting one or more tracks that share a common object detection within their respective data association gates.

Clause 8: The computer-implemented method of clauses 1-7, wherein the at least one region of influence forms a union between one or more data association gates of the conditionally connected track and at least one of the one or more prior connected tracks, and each connected track of the one or more prior connected tracks located within the region of influence can impact an assignment within the region of influence, and each track located outside of the region of influence cannot influence an assignment within the region of influence.

Clause 9: The computer-implemented method of clauses 1-8, wherein detections spanning more than one wedge are provided or associated with a globally unique identifier (GUID), such that correspondence between partial detections across multiple wedges is traceable.

Clause 10: A computing system, comprising: one or more processors; and one or more computer-readable medium storing instructions that, when executed by the one or more processors, cause the computing system to perform operations, the operations comprising: determining, while detecting an active wedge in a scene of an environment surrounding an autonomous vehicle, one or more prior connected tracks in the scene based on a detection of a previous wedge in the scene; generating, based on a local context in the detection of the active wedge, a conditionally connected track in the one or more prior connected tracks; generating at least one region of influence comprising the conditionally connected track, wherein the at least one region of influence forms a union of the conditionally connected track and at least one of the one or more prior connected tracks; and globalizing the scene over the active wedge and the previous wedge by assigning a confidence level to one or more detections in a localized approximation of a full optimal data association.

Clause 11: The computing system of clause 10, wherein the operations further comprise: obtaining the detection of the active wedge including point clouds from a partial revolution that are generated in each of the previous wedge and the active wedge by a rotating light detection and ranging (LiDAR) unit and accumulating the previous wedge and the active wedge to form a globalized LiDAR sweep.

Clause 12: The computing system of clauses 10 and 11, wherein the detection includes at least one of: a detection that lies entirely within the active wedge, a detection that starts in the previous wedge and extends across a boundary into the active wedge, a track completed in the active wedge which starts in the active wedge, or a track which extends beyond a boundary of the active wedge into a future wedge.

Clause 13: The computing system of clauses 10-12, wherein globalizing the scene over the active wedge and the previous wedge, further comprises: matching the detection to one or more existing tracks which include at least one of a track that is previously assigned, a track that is previously uncertain, a track that is previously unassigned, or a new track, wherein: matching the detection to the one or more existing tracks globalizes a local association of a track detected in the active wedge or the previous wedge for a time period of the scene; the confidence level is defined by associating one or more detections of the detection that match with tracks formed in the local context of the region of influence, tracks outside any region of influence, or tracks crossing into the future wedge; and globalizing the scene over the active wedge and the previous wedge causes the localized approximation of the full optimal data association with a result as if operations on the point clouds were performed on a full 360 degree sweep.

Clause 14: The computing system of clauses 10-13, wherein determining the one or more prior connected tracks further comprises: forecasting each track in the scene based on one or more previous detections up to a time of validity based on the active wedge; and generating a union of forecasted tracks that comprises a pairwise connection between one or more forecasted tracks, each pairwise connection determined to be within a pairwise threshold generated from a Euclidian distance of each data association gate for each of the forecasted tracks.

Clause 15: The computing system of clauses 10-14, wherein the operations further comprise: determining a previously connected edge to prune by removing all edges connecting to each track that is located within the active wedge of the scene which does not include any detections from the active wedge within a data association gate.

Clause 16: The computing system of clauses 10-15, wherein determining the conditionally connected track in the one or more prior connected tracks further comprises: determining a conditionally connected edge to add by connecting one or more tracks that share a common object detection within their respective data association gates.

Clause 17: The computing system of clauses 10-16, wherein the at least one region of influence forms a union between one or more data association gates of the conditionally connected track and at least one of the one or more prior connected tracks, and each connected track of the one or more prior connected tracks located within the region of influence can impact an assignment within the region of influence, and each track located outside of the region of influence cannot influence an assignment within the region of influence.

Clause 18: The computing system of clauses 10-17, wherein detections spanning more than one wedge are provided or associated with a globally unique identifier (GUID), such that correspondence between partial detections across multiple wedges is traceable.

Clause 19: A non-transitory computer-readable medium having instructions stored thereon that, when executed by at least one computing device, cause the at least one computing device to perform operations comprising: determining, while detecting an active wedge in a scene of an environment surrounding an autonomous vehicle, one or more prior connected tracks in the scene based on a detection of a previous wedge in the scene; generating, based on a local context in the detection of the active wedge, a conditionally connected track in the one or more prior connected tracks; generating at least one region of influence comprising the conditionally connected track, wherein the at least one region of influence forms a union of the conditionally connected track and at least one of the one or more prior connected tracks; and globalizing the scene over the active wedge and the previous wedge by assigning a confidence level to one or more detections in a localized approximation of a full optimal data association.

Clause 20: The non-transitory computer-readable medium of clause 19, wherein the operations further comprise: matching the detection to one or more existing tracks which include at least one of a track that is previously assigned, a track that is previously uncertain, a track that is previously unassigned, or a new track, wherein: matching the detection to one or more existing tracks globalizes a local association of a track detected in the active wedge or the previous wedge for at least a time period of the scene; the confidence level is defined by associating one or more detections of the detection that match with tracks formed in the local context of the region of influence, tracks outside each region of influence, or tracks crossing into a future wedge; and globalizing the scene over the active wedge and the previous wedge causes the localized approximation of the full optimal data association with a result as if operations on the point clouds were performed on a full 360 degree sweep.

These and other features and characteristics of the present disclosure, as well as, the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the present disclosure.

### BRIEF DESCRIPTION OF THE DRAWINGS

The accompanying drawings are incorporated herein and form a part of the specification.

FIG. 1 is a diagram of non-limiting embodiments or aspects of an exemplary autonomous vehicle system, in accordance with aspects of the present disclosure;

FIG. 2 is a diagram of non-limiting embodiments or aspects of an exemplary architecture for a vehicle in which detecting and preventing an autonomous driving operation, as described herein, may be implemented;

FIG. 3 is an illustration of an illustrative architecture for a light detection and ranging (LiDAR) system;

FIG. 4 is a flowchart of a non-limiting embodiment or aspect of a method for globalizing data associations across LiDAR wedges;

FIGS. 5A and 5B illustrate non-limiting embodiments or aspects of a roadway environment in which systems, apparatuses, and/or methods, as described herein, may be implemented;

FIGS. 6A and 6B illustrate non-limiting embodiments or aspects of a roadway environment in which systems, apparatuses, and/or methods, as described herein, may be implemented;

FIG. 7 illustrates non-limiting embodiments or aspects of a roadway environment in which systems, apparatuses, and/or methods, as described herein, may be implemented; and

FIG. 8 provides non-limiting embodiments or aspects of exemplary computer systems in which systems, apparatuses, and/or methods, as described herein, may be implemented.

In the drawings, like reference numbers generally indicate identical or similar elements. Additionally, generally, the left-most digit(s) of a reference number identifies the drawing in which the reference number first appears.

### DETAILED DESCRIPTION

Some light detection and ranging (LiDAR) systems can create a three-dimensional map of a scene surrounding the system and, therefore, can be used in many applications such as autonomous vehicle control. Most LiDAR systems employ laser pulses and can measure both the intensity and time delay of the reflected laser pulse. The LiDAR system can then compute a LiDAR image comprising an array of LiDAR pixels, each pixel including the range (distance from the LiDAR system) and reflectivity of a detected object in the field around the system. However, LiDAR detections are commonly processed in full 360 degree sweeps and require algorithms for detection to wait for a full 360 degree revolution of the LiDAR before they can begin processing.

According to aspects, the improved methods and systems of the present disclosure may augment 360 degree panoramic LiDAR scans (e.g., sweeping, spinning, rotating, circulating, etc.), by dividing the processing of the 360 degree panoramic LiDAR scans in a globally optimized system and method into a number of scan partition views (e.g., from a sweeping LiDAR system) while enhancing global context based on track information generated from the detection of a previous wedge.

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments or aspects disclosed herein are not to be considered as limiting unless otherwise indicated. In addition, terms of relative position, such as, “vertical” and “horizontal”, “ahead” and “behind”, or “front” and “rear”, when used, are intended to be relative to each other and need not be absolute, and only refer to one possible position of the device associated with those terms depending on the device's orientation.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. Additionally, when terms, such as, “first” and “second” are used to modify a noun, such use is simply intended to distinguish one item from another, and is not intended to require a sequential order unless specifically stated.

In some non-limiting embodiments or aspects, one or more aspects may be described herein, in connection with thresholds (e.g., a tolerance, a tolerance threshold, etc.). As used herein, satisfying a threshold may refer to a value (e.g., a score, an objective score, etc.) being greater than the threshold, more than the threshold, higher than the threshold, greater than or equal to the threshold, less than the threshold, fewer than the threshold, lower than the threshold, less than or equal to the threshold, equal to the threshold, etc.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively send information to the second unit. As another example, a first unit may be in communication with a second unit if at least one intermediary unit (e.g., a third unit located between the first unit and the second unit) processes information received from the first unit and sends the processed information to the second unit. In some non-limiting embodiments or aspects, a message may refer to a network packet (e.g., a data packet and/or the like) that includes data.

As used herein, the term “computing device”, “electronic device”, or “computer” may refer to one or more electronic devices configured to process data. A computing device may, in some examples, include the necessary components to receive, process, and output data, such as, a processor, a display, a memory, an input device, a network interface, and/or the like. A computing device may be included in a device on-board an autonomous vehicle (AV). As an example, a computing device may include an on-board specialized computer (e.g., a sensor, a controller, a data store, a communication interface, a display interface, etc.), a mobile device (e.g., a smartphone, standard cellular phone, or integrated cellular device), a portable computer, a wearable device (e.g., watches, glasses, lenses, clothing, and/or the like), a personal digital assistant (PDA), and/or other like devices. A computing device may also be a desktop computer or other form of non-mobile computer.

As used herein, the terms “client”, “client device”, and “remote device” may refer to one or more computing devices that access a service made available by a server. In some non-limiting embodiments or aspects, a “client device” may refer to one or more devices that facilitate a maneuver by an AV, such as, one or more remote devices communicating with an AV. In some non-limiting embodiments or aspects, a client device may include a computing device configured to communicate with one or more networks and/or facilitate vehicle movement, such as, but not limited to, one or more vehicle computers, one or more mobile devices, and/or other like devices.

As used herein, the term “server” may refer to or include one or more computing devices that are operated by or facilitate communication and processing for multiple parties in a network environment, such as, the Internet, although it will be appreciated that communication may be facilitated over one or more public or private network environments and that various other arrangements are possible. Further, multiple computing devices (e.g., servers, data stores, controllers, communication interfaces, mobile devices, and/or the like) directly or indirectly communicating in the network environment may constitute a “system.” The terms “processor” and “processing device” refer to a hardware component of an electronic device that is configured to execute programming instructions. Except where specifically stated otherwise, the singular term “processor” or “processing device” is intended to include both single-processing device embodiments and embodiments in which multiple processing devices together or collectively perform a process. Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, the term “system” may refer to one or more computing devices or combinations of computing devices, such as, but not limited to, processors, servers, client devices, sensors, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function. The terms “memory,” “memory device,” “data store,” “data storage facility,” and the like each refer to a non-transitory device on which computer-readable data, programming instructions, or both are stored. Except where specifically stated otherwise, the terms “memory,” “memory device,” “data store,” “data storage facility,” and the like are intended to include single device embodiments, embodiments in which multiple memory devices together or collectively store a set of data or instructions, as well as, individual sectors within such devices.

According to some non-limiting embodiments, the term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones, and the like. An “autonomous vehicle” (AV) is a vehicle having a processor, programming instructions and drivetrain components that are controllable by the processor without requiring a human operator. An AV may be fully autonomous in that it does not require a human operator for most or all driving conditions and functions, or it may be semi-autonomous in that a human operator may be required in certain conditions or for certain operations, or that a human operator may override the vehicle's autonomous system and may take control of the vehicle. The AV can be a ground-based AV (e.g., car, truck, bus, etc.), an air-based AV (e.g., airplane, drone, helicopter, or other aircraft), or other types of vehicles (e.g., watercraft).

As used herein, the terms “trajectory” and “trajectories” may refer to a path (e.g., a path through a geospatial area, etc.) with positions of the AV along the path with respect to time, where a “path” generally implies a lack of temporal information, one or more paths for navigating an AV in a roadway for controlling travel of the AV on the roadway. A trajectory may be associated with a map of a geographic area including the roadway. In such an example, the path may traverse a roadway, an intersection, another connection or link of the road with another road, a lane of the roadway, objects in proximity to and/or within the road, and/or the like. For example, a trajectory may define a path of travel on a roadway for an AV that follows each of the rules (e.g., the path of travel does not cross a yellow line, etc.) associated with the roadway. In such an example, an AV that travels over or follows the trajectory (e.g., that travels on the roadway without deviating from the trajectory, etc.) may obey each of the rules or account for constraints (e.g., objects in the roadway, does not cross the yellow line, etc.) associated with the roadway.

As used herein, “map data” and “sensor data” includes data associated with a road (e.g., an identity and/or a location of a roadway of a road, an identity and/or location of a segment of a road, etc.), data associated with an object in proximity to a road (e.g., a building, a lamppost, a crosswalk, a curb of the road, etc.), data associated with a lane of a roadway (e.g., the location and/or direction of a travel lane, a parking lane, a turning lane, a bicycle lane, etc.), data associated with traffic control of a road (e.g., the location of and/or instructions associated with lane markings, traffic signs, traffic lights, etc.), and/or the like. According to some non-limiting embodiments, a map of a geographic location (or area) includes one or more routes (e.g., a nominal route, a driving route, etc.) that include one or more roadways. According to some non-limiting embodiments or aspects, map data associated with a map of the geographic location associates the one or more roadways with an indication of whether an AV can travel on that roadway. As used herein, “sensor data” includes data from one or more sensors. For example, sensor data may include light detection and ranging (LiDAR) point cloud maps (e.g., map point data, etc.) associated with a geographic location (e.g., a location in three-dimensional space relative to the LiDAR system of a mapping vehicle in one or more roadways) of a number of points (e.g., a point cloud) that correspond to objects that have reflected a ranging laser of one or more mapping vehicles at the geographic location (e.g. an object such as a vehicle, a bicycle, a pedestrian, etc. in the roadway). As an example, sensor data may include LiDAR point cloud data that represents objects in the roadway, such as, other vehicles, pedestrians, cones, debris, and/or the like.

As used herein, a “road” refers to a paved or an otherwise improved path between two places that allows for travel by a vehicle (e.g., autonomous vehicle (AV) 102). Additionally or alternatively, a road includes a roadway and a sidewalk in proximity to (e.g., adjacent, near, next to, abutting, touching, etc.) the roadway. In some non-limiting embodiments or aspects, a roadway includes a portion of a road on which a vehicle is intended to travel and is not restricted by a physical barrier or by separation so that the vehicle is able to travel laterally. Additionally or alternatively, a roadway (e.g., a road network, one or more roadway segments, etc.) includes one or more lanes in which a vehicle may operate, such as, a travel lane (e.g., a lane upon which a vehicle travels, a traffic lane, etc.), a parking lane (e.g., a lane in which a vehicle parks), a turning lane (e.g., a lane in which a vehicle turns from), and/or the like. Additionally or alternatively, a roadway includes one or more lanes in which a pedestrian, bicycle, or other vehicle may travel, such as, a crosswalk, a bicycle lane (e.g., a lane in which a bicycle travels), a mass transit lane (e.g., a lane in which a bus may travel), and/or the like. According to some non-limiting embodiments, a roadway is connected to another roadway to form a road network, for example, a lane of a roadway is connected to another lane of the roadway and/or a lane of the roadway is connected to a lane of another roadway. In some non-limiting embodiments, an attribute of a roadway includes a road edge of a road (e.g., a location of a road edge of a road, a distance of location from a road edge of a road, an indication whether a location is within a road edge of a road, etc.), an intersection, connection, or link of a road with another road, a roadway of a road, a distance of a roadway from another roadway (e.g., a distance of an end of a lane and/or a roadway segment or extent to an end of another lane and/or an end of another roadway segment or extent, etc.), a lane of a roadway of a road (e.g., a travel lane of a roadway, a parking lane of a roadway, a turning lane of a roadway, lane markings, a direction of travel in a lane of a roadway, etc.), one or more objects (e.g., a vehicle, vegetation, a pedestrian, a structure, a building, a sign, a lamppost, signage, a traffic sign, a bicycle, a railway track, a hazardous object, etc.) in proximity to and/or within a road (e.g., objects in proximity to the road edges of a road and/or within the road edges of a road), a sidewalk of a road, and/or the like.

As used herein, navigating (e.g., traversing, driving, etc.) a route may involve the creation of at least one trajectory or path through the road network and may include any number of maneuvers or an evaluation of any number of maneuvers (e.g., a simple maneuver, a complex maneuver, etc.), such as, a maneuver involving certain driving conditions, such as, dense traffic, where successfully completing a lane change may require a complex maneuver, like speeding up, slowing down, stopping, or abruptly turning, for example, to steer into an open space between vehicles, pedestrians, or other objects (as detailed herein) in a destination lane. Additionally, in-lane maneuvers may also involve an evaluation of any number of maneuvers, such as, a maneuver to traverse a lane split, an intersection (e.g., a three-leg, a four-leg, a multi-leg, a roundabout, a T-junction, a Y-intersection, a traffic circle, a fork, turning lanes, a split intersection, a town center intersection, etc.), a travel lane (e.g., a lane upon which a vehicle travels, a traffic lane, etc.), a parking lane (e.g., a lane in which a vehicle parks), a bicycle lane (e.g., a lane in which a bicycle travels), a turning lane (e.g., a lane from which a vehicle turns, etc.), merging lanes (e.g., two lanes merging to one lane, one lane ends and merges into a new lane to continue, etc.), and/or the like. Maneuvers may also be based on current traffic conditions that may involve an evaluation of any number of maneuvers, such as, a maneuver based on a current traffic speed of objects in the roadway, a current traffic direction (e.g., anti-routing traffic, wrong-way driving, or counter flow driving, where a vehicle is driving against the direction of traffic and/or against the legal flow of traffic), current accidents or other incidents in the roadway, weather conditions in the geographic area (e.g., rain, fog, hail, sleet, ice, snow, etc.), or road construction projects. In addition, maneuvers may also involve an evaluation of any number of objects in and around the roadway, such as, a maneuver to avoid an object in proximity to a road, such as, structures (e.g., a building, a rest stop, a toll booth, a bridge, etc.), traffic control objects (e.g., lane markings, traffic signs, traffic lights, lampposts, curbs of the road, gully, a pipeline, an aqueduct, a speedbump, a speed depression, etc.), a lane of a roadway (e.g., a parking lane, a turning lane, a bicycle lane, etc.), a crosswalk, a mass transit lane (e.g., a travel lane in which a bus, a train, a light rail, and/or the like may travel), objects in proximity to and/or within a road (e.g., a parked vehicle, a double parked vehicle, vegetation, a lamppost, signage, a traffic sign, a bicycle, a railway track, a hazardous object, etc.), a sidewalk of a road, and/or the like.

In some non-limiting embodiments or aspects, systems and methods for globalizing LiDAR wedge detections are disclosed for optimizing data associations in accordance with approximations of a global LiDAR wedge detection. LiDAR is inherently a streaming data source where the data is processed in a full 360 degree LiDAR scan (e.g., a sweep made by sweeping, spinning, rotating, circulating, etc.), thereby requiring detection algorithms to wait for a full revolution of the LiDAR before they can begin, often taking over 100 milliseconds for a full sweep. In addition, dividing a sweep into multiple components may cause processing problems and issues with global context, where detections in the scene are incomplete, degraded, or completely unusable, precluding use of optimal detection and data association algorithms.

Non-limiting embodiments or aspects of the present disclosure provide improved systems, methods, and computer program products that can obtain the detection of the active wedge in the scene of the environment surrounding the autonomous vehicle, where point clouds from a partial revolution are generated in each of the previous wedge and the active wedge of a rotating LiDAR unit and can be accumulated to form a globalized LiDAR sweep. Each detection may include at least one of: a detection that lies entirely within the active wedge; a detection that starts in the previous wedge and extends across a boundary into the active wedge; a track completed in the active wedge which starts in the active wedge; or a track which extends beyond a boundary of the active wedge into a future wedge.

Globalizing one or more detections may include improved systems and methods for matching detections to existing tracks which include at least one of a track that is previously assigned (e.g., a track that belongs to a region of influence that lies entirely inside the active wedge, a track that is split between the active wedge and the previous wedge, etc.), a track that is previously uncertain (e.g., a track that belongs to a future wedge but includes a data association gate extending into the active wedge, a track with a data association gate in a future wedge and an active wedge, etc.), a track that is previously unassigned, or a new track. Matching detections to existing tracks may include globalizing a local association of tracks detected in the active wedge or the previous wedge for a time period of the scene, where a confidence level is defined by associations of the one or more detections matching with tracks formed in the local context of the region of influence, tracks outside any region of influence, or tracks crossing into a future wedge. Globalizing the one or more detections may cause the localized approximation of the full optimal data association with a result as if operations on the point clouds were performed on a full 360 degree sweep.

Generating the prior connected tracks may include forecasting each track in the scene of the environment surrounding the autonomous vehicle based on previous detections up to a time of validity based on the active wedge and/or generating a union of forecasted tracks that may include a pairwise connection between two or more forecasted tracks, where each pairwise connection is determined to be within a pairwise threshold generated from a Euclidian distance of each data association gate for each of the forecasted tracks. A conditionally connected component may include at least one of a conditionally connected edge to add or a previously connected edge to prune.

Updating the one or more prior connected tracks may include determining a conditionally connected edge to add by connecting one or more tracks that share a common object detection within their respective data association gates and/or determining the previously connected edge to prune by removing all edges connecting to each track that is located within the active wedge of the scene which does not include any detections from the active wedge within its data association gate. Each connected track constituent within the region of influence can impact an assignment of detections to each other object within the region of influence and each track falling outside of the region of influence cannot influence an assignment with respect to any track in the region of influence. Detections spanning more than one wedge are provided or associated with a globally unique identifier (GUID), such that correspondence between partial detections across multiple wedges is traceable. Implementations of the described techniques may include hardware, a method or a process, or computer software on a computer-accessible medium.

In this way, non-limiting embodiments or aspects of the present disclosure provide an improved approach to globally optimal data association using LiDAR wedges, which is based on preserving relevant context and context which degrades quickly as distance from an object increases. In some non-limiting embodiments or aspects, an approximation is more efficiently generated to achieve a full optimal data association solution (e.g., a global optimal data association, etc.) by using only local context from a LiDAR wedge and neighboring wedges.

Further improvements of the present disclosure may include decreasing the end-to-end latency of LiDAR perception pipelines, which may be reduced significantly by operating on wedge-shaped point cloud sectors to eliminate dead (e.g., unused, redundant, inefficient, etc.) wait time. LiDAR wedges may also enable additional pipelining and pre-processing of wedges. Optimal data association routines for a full LiDAR sweep may also be generally worse than a linear complexity in scale (e.g., the time taken increases more than linearly with the increase in the number of inputs) when considering the processing of detections and tracks. LiDAR wedges provide runtime benefits and advantages by breaking the full scene data association problem into N partial scenes (e.g., LiDAR wedges).

In some non-limiting embodiments or aspects, each conditional connected component is, by definition, mutually independent given the active wedge detections. Therefore, further runtime benefit can be realized (without degrading optimality) by further factoring the full active wedge data association problem into N independent scenes (e.g., N independent wedges, N independent parts, etc.), such as, for example, one scene for each conditional connected component. These scenes can then be more accurately globalized with respect to neighboring scenes. In addition, scenes can be globalized in parallel for further runtime, throughput, and latency efficiencies.

Still further efficiency may be gained due to the direct analog between the conditionally connected components graph and a bipartite assignment graph used for matching, by using the conditional connected components graph to prune edges from the bipartite assignment graph to reduce complexity of the assignment problem. Moreover, the graph construction procedure of the present disclosure provides additional accuracy by avoiding redundancy found in systems that extend beyond a full LiDAR sweep and may require duplicate tracks or tracks from different time periods.

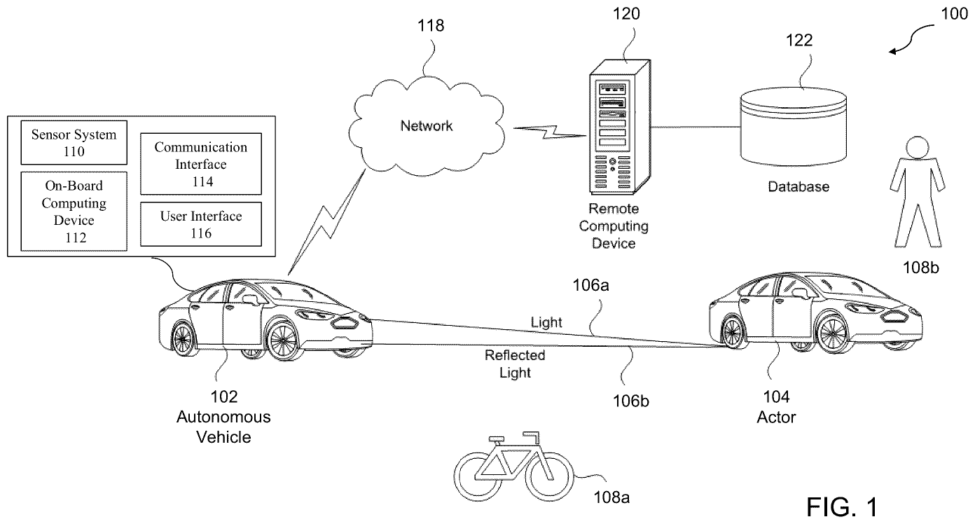

FIG. 1 provides system 100 in which devices, systems, and/or methods, herein, may be implemented. System 100 comprises autonomous vehicle 102 (AV 102) that is traveling along a road in a semi-autonomous or autonomous manner. AV 102 is also referred to herein as vehicle 102.

AV 102 is generally configured to detect objects in the roadway, such as actor 104, bicyclist 108a, and pedestrian 108b in proximity thereto. The objects can include, but are not limited to, a vehicle, such as actor 104, bicyclist 108a (e.g., a rider of a bicycle, an electric scooter, a motorcycle, or the like) and/or pedestrian 108b. Actor 104 may be an autonomous vehicle, semi-autonomous vehicle, or alternatively, a non-autonomous vehicle controlled by a driver.

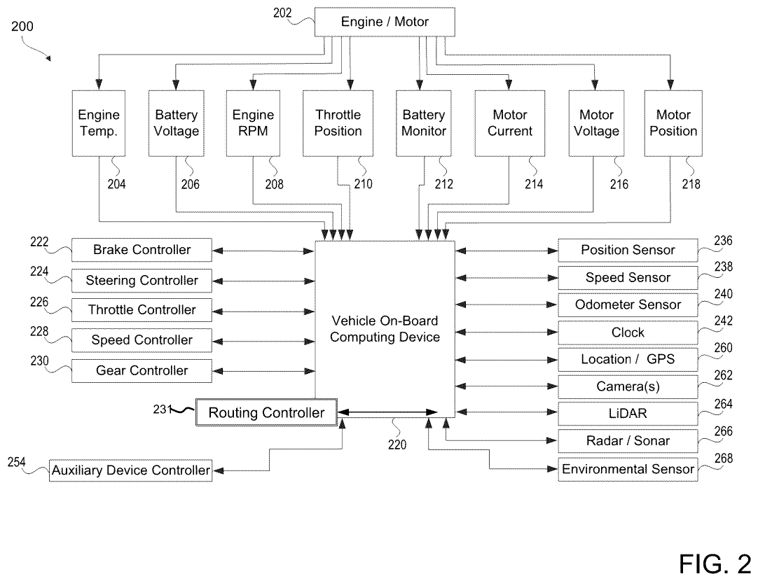

As illustrated in FIG. 1, AV 102 may include sensor system 110, on-board computing device 112, communications interface 114, and user interface 116. AV 102 may further include certain components (as illustrated, for example, in FIG. 2) included in vehicles, which may be controlled by on-board computing device 112 using a variety of communication signals and/or commands, such as, for example, acceleration signals or commands, deceleration signals or commands, steering signals or commands, braking signals or commands, etc.

Sensor system 110 may include one or more sensors that are coupled to and/or are included within AV 102, as illustrated in FIG. 2. For example, such sensors may include, without limitation, a laser detection system, a radio detection and ranging (RADAR) system, a LiDAR system, a sound navigation and ranging (SONAR) system, one or more cameras (e.g., visible spectrum cameras, infrared cameras, etc.), temperature sensors, position sensors (e.g., global positioning system (GPS), etc.), location sensors, fuel sensors, motion sensors (e.g., inertial measurement units (IMU), etc.), humidity sensors, occupancy sensors, or the like. The sensor data can include information that describes the location of objects within the surrounding environment of AV 102, information about the environment itself, information about the motion of AV 102, information about a route of AV 102, and/or the like. As AV 102 moves over a surface, at least some of the sensors may collect data pertaining to the surface.

As will be described in greater detail, AV 102 may be configured with a LiDAR system (e.g., LiDAR 264 of FIG. 2.) The LiDAR system may be configured to transmit light pulse 106a to detect objects located within a distance or range of distances of AV 102. Light pulse 106a may be incident on one or more objects (e.g., actor 104, bicyclist 108a, pedestrian 108b) and be reflected back to the LiDAR system. Reflected light pulse 106b incident on the LiDAR system may be processed to determine a distance of that object to AV 102. The reflected light pulse 106b may be detected using, in some non-limiting embodiments, a photodetector or array of photodetectors positioned and configured to receive the light reflected back into the LiDAR system. LiDAR information, such as detected object data, is communicated from the LiDAR system to on-board computing device 112 (e.g., one or more processors of AV 102, vehicle on-board computing device 220 of FIG. 2, etc.). AV 102 may also communicate LiDAR data to remote computing device 120 (e.g., cloud processing system) over communications network 118. Remote computing device 120 may be configured with one or more servers to process one or more processes of the technology described herein. Remote computing device 120 may also be configured to communicate data/instructions to/from AV 102 over network 118, to/from server(s) and/or database(s) 122.

In some non-limiting embodiments or aspects, LiDAR systems for collecting data pertaining to the surface may be included in systems other than AV 102, such as, without limitation, other vehicles (autonomous or driven), mapping vehicles, robots, satellites, etc.

Network 118 may include one or more wired or wireless networks. For example, network 118 may include a cellular network (e.g., a long-term evolution (LTE) network, a code division multiple access (CDMA) network, a 3G network, a 4G network, a 5G network, another type of next generation network, etc.). The network may also include a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, and/or the like, and/or a combination of these or other types of networks.

AV 102 may retrieve, receive, display, and edit information generated from a local application or obtain track data, confidence level logic, optimizing data, association data, information, and/or the like, delivered via network 118 from database 122. Database 122 may be configured to store and supply raw data, indexed data, structured data, map data, program instructions, or other configurations as is known.

Communications interface 114 may be configured to allow communication between AV 102 and external systems, such as, for example, external devices, sensors, other vehicles, servers, data stores, databases, and/or the like. Communications interface 114 may utilize any now or hereafter known protocols, protection schemes, encodings, formats, packaging, etc. such as, without limitation, Wi-Fi, an infrared link, Bluetooth, etc. User interface 116 may be part of peripheral devices implemented within AV 102 including, for example, a keyboard, a touch screen display device, a microphone, and a speaker, etc.

FIG. 2 illustrates an exemplary system architecture 200 for a vehicle, in accordance with aspects of the disclosure. AV 102 (or other vehicles such as actor 104) of FIG. 1 can have the same or similar system architecture as that shown in FIG. 2. Thus, the following discussion of system architecture 200 is sufficient for understanding vehicle(s) 102 and 104 of FIG. 1. However, other types of vehicles are considered within the scope of the technology described herein and may contain more or less elements as described in association with FIG. 2. As a non-limiting example, an airborne vehicle may exclude brake or gear controllers, but may include an altitude sensor. In another non-limiting example, a water-based vehicle may include a depth sensor. One skilled in the art will appreciate that other propulsion systems, sensors and controllers may be included based on a type of vehicle, as is known.

As shown in FIG. 2, a system architecture 200 of AV 102 includes an engine or motor 202 and various sensors 204-218 for measuring various parameters of the vehicle. In gas-powered or hybrid vehicles having a fuel-powered engine, the sensors may include, for example, an engine temperature sensor 204, a battery voltage sensor 206, an engine Rotations per Minute (RPM) sensor 208, and a throttle position sensor 210. If the vehicle is an electric or hybrid vehicle, then the vehicle may have an electric motor, and accordingly includes sensors such as a battery monitoring system 212 (to measure current, voltage and/or temperature of the battery), motor current 214 and motor voltage 216 sensors, and motor position sensors 218 such as resolvers and encoders.

Operational parameter sensors that are common to both types of vehicles include, for example: position sensor 236 such as an accelerometer, gyroscope and/or inertial measurement unit; speed sensor 238; and odometer sensor 240. The vehicle also may have clock 242 that the system uses to determine vehicle time during operation. Clock 242 may be encoded into vehicle on-board computing device 220, it may be a separate device, or multiple clocks may be available.

The vehicle also includes various sensors that operate to gather information about the environment in which the vehicle is traveling. These sensors may include, for example: location sensor 260 (e.g., a Global Positioning System (GPS) device); object detection sensors such as one or more cameras 262; LiDAR 264; and/or a radar and/or sonar system 266. The sensors also may include environmental sensors 268 such as a precipitation sensor and/or ambient temperature sensor. The object detection sensors may enable the vehicle to detect objects that are within a given distance range of the vehicle (e.g., AV 102) in any direction, while the environmental sensors collect data about environmental conditions within the vehicle's area of travel.

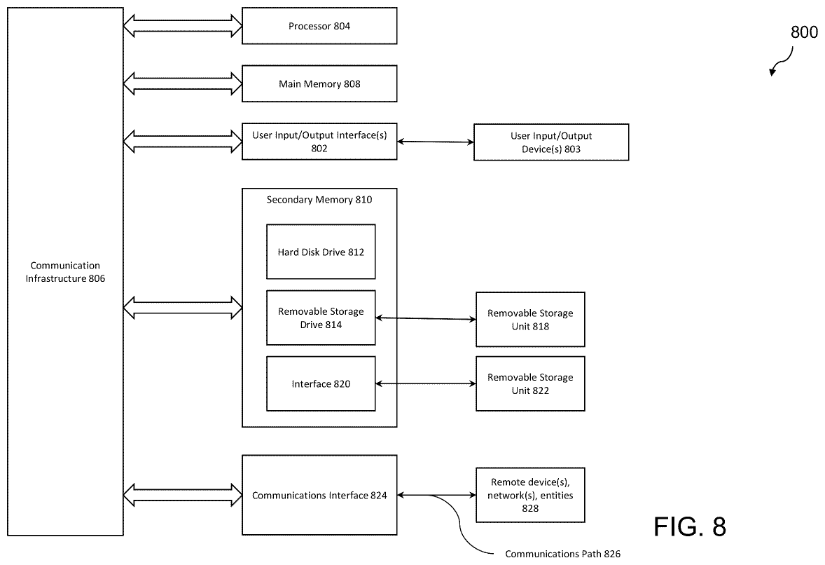

During operations, information is communicated from the sensors to vehicle on-board computing device 220. Vehicle on-board computing device 220 is implemented using the computer system of FIG. 8. Vehicle on-board computing device 220 analyzes the data captured by the sensors and optionally controls operations of the vehicle based on results of the analysis. For example, vehicle on-board computing device 220 may control one or more of: braking via brake controller 222; direction via steering controller 224; speed and acceleration via throttle controller 226 (in a gas-powered vehicle) or motor speed controller 228 (such as a current level controller in an electric vehicle); differential gear controller 230 (in vehicles with transmissions); other controllers, and/or the like. Auxiliary device controller 254 may be configured to control one or more auxiliary devices, such as testing systems, auxiliary sensors, mobile devices transported by the vehicle, and/or the like.

Geographic location information may be communicated from location sensor 260 to vehicle on-board computing device 220, which may then access a map of the environment that corresponds to the location information to determine known fixed features of the environment such as streets, buildings, stop signs, and/or stop/go signals. Captured images from cameras 262 and/or object detection information captured from sensors such as LiDAR 264 is communicated from those sensors to vehicle on-board computing device 220. The object detection information and/or captured images are processed by vehicle on-board computing device 220 to detect objects in proximity to vehicle 102 (or AV 102). Any known or to be known technique for making an object detection based on sensor data and/or captured images can be used in the embodiments disclosed herein.

LiDAR information is communicated from LiDAR 264 to vehicle on-board computing device 220. Additionally, captured images are communicated from camera(s) 262 to vehicle on-board computing device 220. The LiDAR information and/or captured images are processed by vehicle on-board computing device 220 to detect objects in proximity to vehicle 102 (or AV 102). The manner in which the object detections are made by vehicle on-board computing device 220 includes such capabilities detailed in this disclosure.

Vehicle on-board computing device 220 may include and/or may be in communication with routing controller 231 that generates a navigation route from a start position to a destination position for an autonomous vehicle. Routing controller 231 may access a map data store to identify possible routes and road segments that a vehicle can travel on to get from the start position to the destination position. Routing controller 231 may score the possible routes and identify a preferred route to reach the destination. For example, routing controller 231 may generate a navigation route that minimizes Euclidean distance traveled or other cost function during the route, and may further access the traffic information and/or estimates that can affect an amount of time it will take to travel on a particular route. Depending on implementation, routing controller 231 may generate one or more routes using various routing methods, such as Dijkstra's algorithm, Bellman-Ford algorithm, or other algorithms. Routing controller 231 may also use the traffic information to generate a navigation route that reflects expected conditions of the route (e.g., current day of the week or current time of day, etc.), such that a route generated for travel during rush-hour may differ from a route generated for travel late at night. Routing controller 231 may also generate more than one navigation route to a destination and send more than one of these navigation routes to a user for selection by the user from among various possible routes.

In various embodiments, vehicle on-board computing device 220 may determine perception information of the surrounding environment of AV 102. Based on the sensor data provided by one or more sensors and location information that is obtained, vehicle on-board computing device 220 may determine perception information of the surrounding environment of AV 102. The perception information may represent detected objects that an ordinary driver would perceive in the surrounding environment of a vehicle. The perception data may include information relating to one or more objects in the environment of AV 102. For example, vehicle on-board computing device 220 may process sensor data (e.g., LiDAR or RADAR data, camera images, etc.) in order to identify objects and/or features in the environment of AV 102. Vehicle on-board computing device 220 may process sensor data in an active wedge and a previous wedge. In such an example, vehicle on-board computing device 220 may globalize the active wedge and the previous wedge to approximate global optimized association data in accordance with a full sweep of the environment surrounding AV 102. The objects may include traffic signals, road way boundaries, other vehicles, pedestrians, and/or obstacles, etc. Vehicle on-board computing device 220 may use any now or hereafter known object recognition algorithms, video tracking algorithms, and computer vision algorithms (e.g., track objects frame-to-frame iteratively over a number of time periods) to determine the perception.

In some non-limiting embodiments, vehicle on-board computing device 220 may also determine, for one or more identified objects in the environment, the current state of the object. The state information may include, without limitation, for each object: current location; current speed and/or acceleration: current heading; current pose; current shape, size, or footprint; type (e.g., vehicle vs. pedestrian vs. bicycle vs. static object or obstacle); and/or other state information.

Vehicle on-board computing device 220 may perform one or more prediction and/or forecasting operations. For example, vehicle on-board computing device 220 may predict future locations, trajectories, and/or actions of one or more objects. For example, vehicle on-board computing device 220 may predict the future locations, trajectories, and/or actions of the objects based at least in part on perception information (e.g., the state data for each object comprising an estimated shape and pose determined as discussed below), location information, sensor data, and/or any other data that describes the past and/or current state of the objects, AV 102, the surrounding environment, and/or their relationship(s). For example, if an object is a vehicle and the current driving environment includes an object, vehicle on-board computing device 220 may predict an action of the object based on a local context formed from at least an active LiDAR wedge.

In various embodiments, vehicle on-board computing device 220 may determine a motion plan for the autonomous vehicle. For example, vehicle on-board computing device 220 may determine a motion plan for the autonomous vehicle based on the perception data and/or the prediction data. Specifically, given predictions about the future locations of proximate objects and other perception data, vehicle on-board computing device 220 can determine a motion plan for AV 102 that best navigates the autonomous vehicle relative to the objects at their future locations.

In some non-limiting embodiments, vehicle on-board computing device 220 may receive predictions and make a decision regarding how to handle objects and/or actors in the environment of AV 102. For example, for a particular actor (e.g., a vehicle with a given speed, direction, turning angle, etc.), vehicle on-board computing device 220 decides whether to overtake, yield, stop, and/or pass based on, for example, traffic conditions, map data, state of the autonomous vehicle, etc. Furthermore, vehicle on-board computing device 220 also plans a path for AV 102 to travel on a given route, as well as driving parameters (e.g., distance, speed, and/or turning angle). That is, for a given object, vehicle on-board computing device 220 decides what to do with the object and determines how to do it. For example, for a given object, vehicle on-board computing device 220 may decide to pass the object and may determine whether to pass on the left side or the right side of the object (including motion parameters such as speed). Vehicle on-board computing device 220 may also assess the risk associated with a detected object and AV 102. If the risk exceeds an acceptable threshold, it may determine whether it can be avoided if the autonomous vehicle follows a defined vehicle trajectory and/or implements one or more dynamically generated maneuvers in a pre-defined time period (e.g., N milliseconds).

As discussed above, planning and control data related to maneuvering the autonomous vehicle in the roadway is generated for execution. Vehicle on-board computing device 220 may, for example, control braking via a brake controller; direction via a steering controller; speed and acceleration via a throttle controller (in a gas-powered vehicle) or a motor speed controller (such as a current level controller in an electric vehicle); a differential gear controller (in vehicles with transmissions); and/or other controllers.

In the various embodiments discussed in this document, the description may state that the vehicle or a controller included in the vehicle may implement programming instructions that cause the controller to make decisions and use the decisions to control operations of one or more vehicle systems via the vehicle control system of the vehicle. However, the embodiments are not limited to this arrangement, as in various embodiments the analysis, decision making, and/or operational control may be handled in full or in part by other computing devices that are in electronic communication with the vehicle's on-board controller and/or vehicle control system. Examples of such other computing devices include an electronic device (such as, a smartphone) associated with a person who is riding in the vehicle, as well as, a remote server that is in electronic communication with the vehicle via a wireless network. The processor of any such device may perform the operations that will be discussed below.

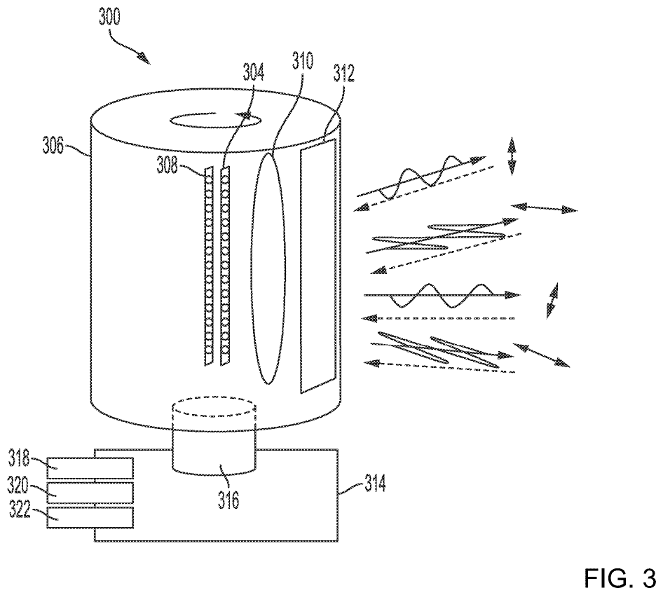

FIG. 3 is an illustration of an illustrative LiDAR system 300. LiDAR system 264 of FIG. 2 may be the same as or substantially similar to LiDAR system 300.

As shown in FIG. 3, LiDAR system 300 may include a rotatable housing 306, which may be rotated 360 degree about a central axis such as hub or axle 316. Housing 306 may include emitter/receiver aperture 312 made of a material transparent to light. Although a single aperture is shown in FIG. 3, non-limiting embodiments or aspects of the present disclosure are not limited in this regard. In other scenarios, multiple apertures for emitting and/or receiving light may be provided. Either way, LiDAR system 300 can emit light through one or more of aperture(s) 312 and receive reflected light back toward one or more of aperture(s) 312 as housing 306 rotates around the internal components. In an alternative scenario, the outer shell of housing 306 may be a stationary dome, at least partially made of a material that is transparent to light, with rotatable components inside of housing 306.

Inside the rotating shell or stationary dome is light emitting unit 304 that is configured and positioned to generate and emit pulses of light through aperture 312 or through the transparent dome of housing 306 via one or more laser emitter chips or other light emitting devices. Emitter system 304 may include any number of individual emitters (e.g., 8 emitters, 64 emitters, 128 emitters, etc.). The emitters may emit light of substantially the same intensity or of varying intensities. The individual beams emitted by light emitter system 304 may have a well-defined state of polarization that is not the same across the entire array. As an example, some beams may have vertical polarization and other beams may have horizontal polarization. LiDAR system 300 may include light detector 308 containing a photodetector or array of photodetectors positioned and configured to receive light reflected back into the system. Emitter system 304 and light detector 308 may rotate with the rotating shell, or emitter system 304 and light detector 308 may rotate inside the stationary dome of housing 306. One or more optical element structures 310 may be positioned in front of light emitting unit 304 and/or light detector 308 to serve as one or more lenses and/or waveplates that focus and direct light that is passed through optical element structure 310.

One or more optical element structures 310 may be positioned in front of a mirror to focus and direct light that is passed through optical element structure 310. As described herein below, LiDAR system 300 may include optical element structure 310 positioned in front of a mirror and connected to the rotating elements of LiDAR system 300 so that optical element structure 310 rotates with the mirror. Alternatively or in addition, optical element structure 310 may include multiple such structures (e.g., lenses, waveplates, etc.). In some non-limiting embodiments or aspects, multiple optical element structures 310 may be arranged in an array on or integral with the shell portion of housing 306.

In some non-limiting embodiments or aspects, each optical element structure 310 may include a beam splitter that separates light that the system receives from light that the system generates. The beam splitter may include, for example, a quarter-wave or half-wave waveplate to perform the separation and ensure that received light is directed to the receiver unit rather than to the emitter system (which could occur without such a waveplate as the emitted light and received light should exhibit the same or similar polarizations).

LiDAR system 300 may include power unit 318 to power light emitting unit 304, motor, and electronic components. LiDAR system 300 may include an analyzer 314 with elements such as processor 322 and non-transitory computer-readable memory 320 containing programming instructions that are configured to enable the system to receive data collected by the light detector unit, analyze the data to measure characteristics of the light received, and generate information that a connected system can use to make decisions about operating in an environment from which the data was collected. Analyzer 314 may be integral with the LiDAR system 300 as shown, or some or all of analyzer 314 may be external to LiDAR system 300 and communicatively connected to LiDAR system 300 via a wired and/or wireless communication network or link.

In some non-limiting embodiments or aspects, a LiDAR sweep may be a point cloud accumulated from a full 360 degree revolution of a rotating LiDAR unit. In another aspect, a LiDAR wedge includes a point cloud accumulated from a partial revolution of a rotating LiDAR unit. As an example, consecutive wedges can be accumulated and combined to form a full 360 degree LiDAR sweep (i.e., a full LiDAR sweep). For example, AV 102 obtains and combines the detection of the active wedge and the previous wedge by accumulating point clouds from a partial revolution in each of the previous wedge and the active wedge of a rotating LiDAR unit that can be combined to form (e.g., represent, match, etc.) a globalized LiDAR sweep. In such an example, an active wedge and a previous wedge may be combined, or alternatively, a previous wedge and an active wedge may be combined to form a full sweep.

In some non-limiting embodiments or aspects, an active wedge may be a LiDAR wedge that is currently being processed.

In some non-limiting embodiments or aspects, a previous wedge may be a previous wedge to be processed and may be rotationally adjacent to the active wedge in the direction opposite the rotation of the LiDAR unit. In another example, a future wedge may be the next wedge to be processed and may be rotationally adjacent to the active wedge in the same direction of rotation as the LiDAR unit.

In some non-limiting embodiments or aspects, a previous wedge boundary may be a boundary resting (e.g., positioned, dividing, etc.) between a previous wedge and an active wedge. In another example, a future wedge boundary may be a boundary resting (e.g., positioned, dividing, etc.) between an active wedge and a future wedge.

In some non-limiting embodiments or aspects, AV 102 detects an active wedge in a scene of an environment surrounding AV 102. While detecting the active wedge, AV 102 solves or creates a connected components graph, by connecting all or a portion of the previous connected tracks (e.g., prior detected objects, components, etc.) in the scene of the environment. In some examples, a track may already be assigned in a previous wedge (e.g., include a GUID that can be used to identify the track, a stored GUID, a data field, etc.), such as, for example, when it crosses a wedge boundary.

In some non-limiting embodiments or aspects, a data association gate is configured to surround a track. For example, a data association gate represents and defines a spatial region surrounding a track, beyond which a detection will not be considered for assignment with the track.

In some non-limiting embodiments or aspects, a track (e.g., a pedestrian track, a vehicle track, etc.) is a type of object (e.g., any type of detectable object) that has been previously detected (e.g., tracked, etc.) in the roadway, such that the system is programmed or configured for keeping and updating a historical record of a track of the object over time. Tracks are estimates of object movement in the environment that are based on the whole history of data. When receiving a set of detections, a check is made for every detection in the set of detections. For those detections that do not correspond to a track, AV 102 may create a new track or view each of the detections and determine if it corresponds to existing tracks to determine if it is something new.

An edge between tracks is used to chain the tracks and the detections together by using the data association gates. If AV 102 can connect or chain the tracks based on the gates for any given track or detection, it can tell which track or condition can impact the decision.

In some examples, AV 102 generates a prior connected component graph (e.g., one or more prior connected tracks, etc.). The prior connected components may include tracks representing a vehicle traversing a roadway turning onto a roadway, yielding for a pedestrian, parking in a parallel spot, or traversing a route, and/or the like. The scene of the environment includes roadways and objects, some of the objects may be moving in the geographical area based on local context in a detection of a previous wedge in the scene of the environment.

In some examples, the prior connected components are previously determined based on a local context in the detection of the active wedge. The prior connected components may also include conditionally connected tracks, the condition may involve an occurrence in the local context in a prior connected track (e.g., a confirmation of association such as a reoccurring association, a common association, no association, etc.). In some examples, a conditionally connected track may be one that is added due to a detection of information (e.g., in an active wedge, across a previous and active wedge, etc.) confirming the addition, or alternatively, confirming removal.

In some non-limiting embodiments, AV 102 processes a global context using a local context. In an example, AV 102 aggregates detected information that follows from an incomplete wedge to deduce the global context. In some examples, local context is assessed on independent grounds. AV 102 understands (e.g., learns, is configured, includes logic to handle or specify actions, etc.), from local context, (e.g., associations, assignments, confidence level, velocity, forecasts, etc.) how some actions are triggered. Actions are triggered when the contribution of an action to its local context is in some sense participatory, and in some examples, indirect. Such actions should be triggered on the basis of the contribution relative to its local context (e.g., confidence level, local meaning, etc.).

For example, the contribution of a region of influence is a union of tracks, associated as a result of a probability built into a series of data association gates (i.e., those gates of each other connected track). The association of the track to the region of influence increases the confidence level in the track.

In some non-limiting embodiments, AV 102 processes using local context and globalizes the scene. Globalizing uses local context across the two wedges, over the active wedge and the previous wedge. The confidence level assigned to the detections are used to generate an approximation of a full LiDAR sweep. The localized approximation of a full optimal data association provides a technical feature of processing information while detecting a portion of the same scene. AV 102 then globalizes detections. AV 102 uses the optimal data association to navigate with the vehicle and perceive objects in the environment. AV 102 matches detections to existing tracks using only a local context in a combination of the active wedge and the previous wedge.

In some examples, AV 102 detects an active wedge while determining one or more prior connected tracks in the scene of the environment based on local context in a detection of a previous wedge in the scene of the environment. AV 102 is configured to obtain a detection of an active wedge in the scene of the environment surrounding the autonomous vehicle. As an example, AV 102 includes sensor system 110 for detecting objects in the roadway. AV 102 assigns a condition to a connected track in the one or more prior connected tracks to a conditionally connected detection based on a local context related to detection of the active wedge. AV 102 generates a region of influence comprising connected tracks, wherein each connected track constituent includes a track within a union of one or more data association gates of each other connected track, each of the data association gates surrounding a track at a predetermined threshold. AV 102 generates a global optimized data association. AV 102 globalizes one or more detections by generating an approximation of an optimal data association using a local context formed in a combination of the active wedge and the previous wedge of the scene for matching LiDAR detections to existing tracks.

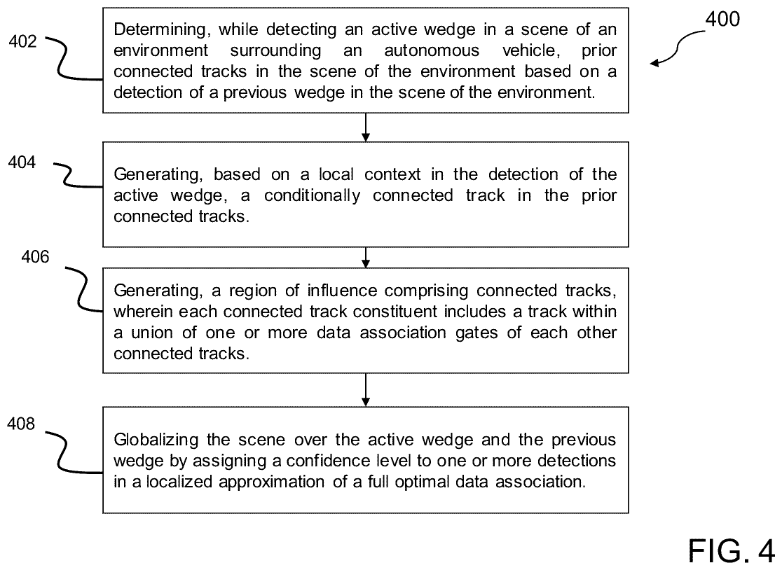

FIG. 4 illustrates a flowchart of a non-limiting embodiment or aspect of process 400 for globalizing data associations across LiDAR wedges in autonomous vehicle systems (e.g., self-driving systems of FIG. 1 and an autonomy vehicle control stack of FIG. 3, etc.). In some non-limiting embodiments or aspects, one or more of the steps of process 400 for globalizing data association across LiDAR wedges are performed (e.g., completely, partially, and/or the like) by AV 102 (e.g., on-board computing device 112, one or more devices of AV 102, information generated from and/or received from AV 102, etc.). In some non-limiting embodiments or aspects, one or more of the steps of process 400 may be performed (e.g., completely, partially, and/or the like) by one or more components of AV system architecture 200 of FIG. 2, one or more processors of a LiDAR system 400 of FIG. 3, one or more processors of a self-driving system of AV 102, or based on information received from autonomy systems (e.g., data related to an on-board autonomous vehicle system, data related to an on-board autonomous vehicle service provider, data related to a device of on-board autonomous vehicle system, data about an on-board vehicle service, data related to an on-board vehicle controller or software program, data related to a sensor of an on-board vehicle system, and/or the like.

As shown in FIG. 4, at step 402, process 400 may include determining, while detecting an active wedge in a scene of an environment surrounding an autonomous vehicle, one or more prior connected tracks in the scene of the environment based on a detection of a previous wedge in the scene of the environment. In some non-limiting embodiments or aspects, for example, AV 102 (e.g., on-board computing device 112, one or more processors of on-board computing device 112) determines, while detecting an active wedge in a scene of an environment surrounding an autonomous vehicle, one or more prior connected tracks in the scene of the environment based on a detection of a previous wedge in the scene of the environment.

AV 102 provides one or more LiDAR sensors and the LiDAR wedge includes point cloud data generated with the one or more LiDAR sensors. In such an example, the one or more LiDAR sensors are rotated to generate sensor data packets for each respective future wedge of the scene. A wedge comprises a point cloud accumulated from a partial revolution of a rotating LiDAR unit, wherein consecutive wedges can be accumulated to form a LiDAR sweep of the scene.

An active wedge is associated with a most recently completed sweep of the scene. A full sweep can include two or more wedges, for example a previous wedge may include 180 degrees and an active wedge may be 180 degrees, so that together they may be combined to form a full 360 degree sweep. In some examples, a wedge can be a predetermined number of degrees between 0 and 360 degrees, such as between 160 degrees and 200 degrees. In such an example, if the previous wedge is 160 degrees, the next wedge (i.e., the active wedge) may be 200 degrees to ensure coverage of the full 360 degree sweep if the sweep consists of two wedges. In other examples, a wedge may be dynamically formed by AV 102. AV 102 may be configured to generate a wedge on environmental variations, such as an object or other mover in the roadway, a partition of a roadway, road signs, or an intersection.

In some non-limiting embodiments or aspects, AV 102 receives, obtains, or stores a detection message which provides detection information. For example, AV 102 obtains a detection message, with a detection that includes at least one of: a detection that lies entirely within the active wedge, a detection that starts in the previous wedge and extends across a boundary into the active wedge, a track completed in the active wedge which starts in the active wedge, or a track which extends beyond a boundary of the active wedge into the future wedge.

An approximation to the full optimal data association solution can be achieved by using only local context, where local context is found in information of the LiDAR wedges. An active wedge provides relevant context before degradation and context degrades (e.g., relevant context degrades quickly as distance from an object increases in a predictable way).

In some non-limiting embodiments or aspects, AV 102 determines the prior connected tracks. The prior connected tracks are connected components, where a connected component is a component of an undirected graph (e.g., a subgraph in which each pair of components is connected with each other component in the subgraph via a path). A set of tracks forms a connected component in an undirected graph if any track from the set of tracks can reach any other track by traversing edges (e.g., a reachable component). In connected components, all the nodes can always be reachable from each other.

In some non-limiting embodiments or aspects, AV 102 forecasts (e.g., predicts, estimates, approximates, etc.) each track in the scene of the environment surrounding the autonomous vehicle based on detections of the previous wedge (e.g., previous tracks, estimated velocity of an object, etc.).

AV 102 can use the forecasts to generate a union of tracks. For example, a union of tracks includes tracks having a pairwise connection between two or more forecasted tracks. For example, each pairwise connection is determined to be within a pairwise threshold of a data association gate. The data association gate is a spatial region surrounding a track, beyond which a detection will not be considered for assignment with the track. The data association gates are configured to form a threshold distance for determining a Euclidian distance between each of the forecasted tracks.

In some non-limiting embodiments or aspects, AV 102 generates or determines a prior connected components graph by finding a union of the forecasted tracks. The union of forecasted tracks is based on a pairwise connection threshold. In such an example, the pairwise connection threshold is equal to a Euclidian distance representing the sum of the pair of data association gates for each of the individual tracks (e.g., track data associated with each track). In such an example, if the track is within the Euclidian distance of the pairwise connection threshold found by summing the data association gates, an assignment of the detection is made to the forecasted track.

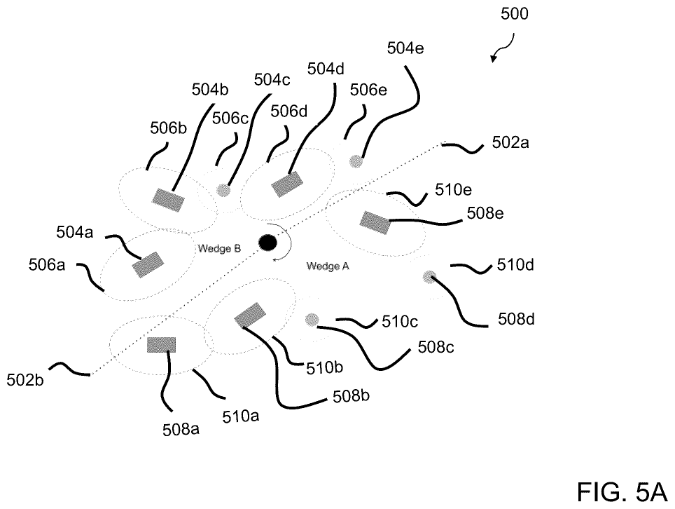

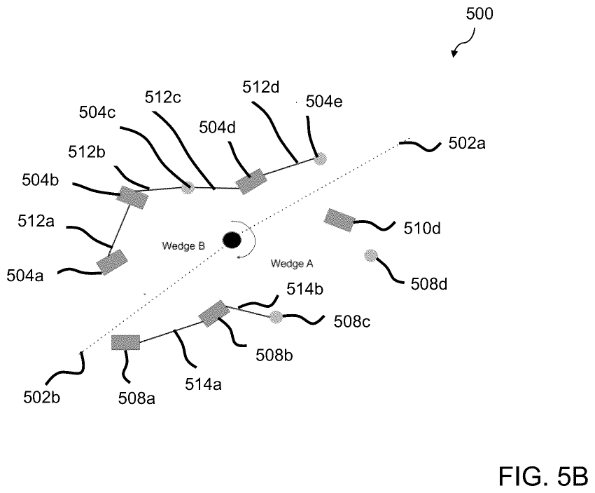

In some examples, and also with further reference to FIG. 5A, an exemplary illustration includes a global data association scene for dividing a sweep into two LiDAR wedges along wedge boundaries 502a and 502b, where sensor system 110 of AV 102 includes LiDAR 264 at a central location indicated by the black circle, with an indicated spin direction. Tracks 504a-504e and 508a-508e represent location estimates (e.g., forecasts, predictions, etc.) of objects previously detected by LiDAR 264 in the surrounding environment surrounding AV 102. Data association gates 506a-506e and 510a-510e (e.g., represented by the dashed ellipses) are data association gates corresponding to tracks 504a-504e and 508a-508e. In some examples, AV 102 (e.g., one or more processors of AV 102, etc.) has previously detected a track in the surrounding environment and has previously instantiated a historical record of a track as it moves over time in the surrounding environment. In other examples, AV 102 (e.g., one or more processors of AV 102) has not previously detected a track, and in such a case, will presently instantiate a historical record of the track to record movements over time in the surrounding environment. Tracks 504a, 504b, 504d, 508a, 508b, and 508e are rectangular in shape and denote detected objects which are estimated to represent vehicle tracks along with corresponding data association gates 506a, 506b, 506d, 510a, 510b, and 510e. Tracks 504c, 504e, 508c, and 508d (e.g., represented by circles) denote detected objects which are estimated to represent pedestrian tracks are shown with corresponding data association gates 506c, 506e, 510c, and 510d.

In some non-limiting embodiments or aspects, connected components are generated while LiDAR 264 of AV 102 perceives objects in wedge A. For example, since the active wedge has not yet been obtained, tracks 508a-508e and data association gates 510a-510e are forecast by AV 102, the forecast representing a prediction of a location based on historical data, including location of tracks previously detected, heading information, velocity, other movers in the area, other objects in the area, and/or the like.

With reference to FIG. 5B, an exemplary illustration includes exemplary connected tracks resulting from the global data association scene for dividing a sweep into two LiDAR wedges of FIG. 5B, where sensor system 110 of AV 102 includes LiDAR 264 at a central location indicated by the black circle, with an indicated spin direction. Wedge boundaries 502a and 502b are shown dividing Wedge A and Wedge B. Also shown are graph edges 512a, 512b, 512c, 512d, 514a, and 514b, that represent connections between components (e.g., tracks). For example, edges 512a, 512b, 512c, 512d (e.g., stored connections, graph edges, etc.) represent connections between tracks 504a-504e. Graph edges 514a, and 514b represent connections between tracks 508a, 508b, and 508c.

In some non-limiting embodiments or aspects, multi-wedge processing provides capabilities for additional pipelining and pre-processing. However, in some non-limiting embodiments, there is a runtime advantage to breaking the full data association problem (e.g., the full sweep or scene) into N partial scenes (i.e., one for each wedge). However, in some examples, detections and tracks falling in regions of influence that breach wedge boundaries will be processed by AV 102 in both wedges.

In some non-limiting embodiments or aspects, a previous wedge is valid up to a wedge boundary dividing the previous wedge from the active wedge. Each LiDAR wedge includes detections that are forecast up to a time of validity as delineated in FIGS. 5A and 5B by the wedge boundaries 502a and 502b (e.g., a time associated with a wedge after which the wedge should be considered obsolete and ignored). Each LiDAR wedge is valid up to a time of validity (e.g., a boundary based on time, distance, or position in a roadway, and/or the like). In such an example, the time of validity forms a boundary between a previous wedge and an active wedge (e.g., sweep), and is used to validate or invalidate a wedge based on a time indicating when detection of a wedge occurred, after which the wedge should be considered obsolete and ignored.

In some non-limiting embodiments or aspects, the time of validity is generated from a timestamp of the detections (e.g., one or more timestamps, such that each individual timestamp of the one or more timestamps is associated with a unique detection in the wedge, etc.) in the LiDAR wedge (i.e. the time at which the data is valid or invalid). For example, the time of validity of an individual LiDAR point is a timestamp of the corresponding laser fired or applied by the sensor. In another example, the time of validity of a LiDAR sweep (i.e., a sweep including a full 360 degree or a partial revolution of the LiDAR) comprises an interval (e.g., a range, etc.) of times which correspond to times of validity, such that, the time of validity may include a starting time of validity, an ending time of validity, and many times of validity in between for each discrete LiDAR detection (e.g., individual LiDAR detections, while the LiDAR sweep is valid for the entire interval. However, an interval may cause a blur (e.g., interval blurring, etc.) over its corresponding points to occur due to AV/sensor motion during a sweep period (e.g., referred to as “AV motion compensation”, and/or the like). In such an example, to avoid or eliminate interval blurring, the range of points for each LiDAR sweep may be projected into a common coordinate frame, and AV 102 may be configured to use the first point in the LiDAR sweep from the AV coordinate frame at the time of validity (e.g., the time of validity of the AV coordinate frame in which the LiDAR points are described after motion compensation, etc.). In this way, the wedge or the sweep time of validity is available as soon as the AV coordinate frame includes the time of validity of the first point in the LiDAR sweep (and ahead of the corresponding detection messages as they start to arrive) and comprises a duration that lasts until the time of validity of the last point in the LiDAR sweep of an AV coordinate frame at the time of validity, or alternatively, until the first point in the next LiDAR sweep arrives.

In some non-limiting embodiments or aspects, AV 102 stores wedge information. For example, AV 102 stores tracks and track data (and information) in a local track store based at least in part on tracks in the active wedge and the previous wedge. The local track store is indicative of one or more track associations across a full detection comprising the active wedge and the previous wedge of the scene. Detections spanning more than one wedge are provided or associated with a GUID, such that correspondence between partial detections across multiple wedges is traceable.

In some non-limiting embodiments or aspects, AV 102 augments 360 degree panoramic LiDAR scans (e.g., sweeps), by dividing and augmenting each LiDAR wedge in the 360 degree panoramic into wedges. The wedges are each a partial sweep of the surrounding environment (e.g., received from a sweeping LiDAR system). In such an example, AV 102 is configured to provide a 360 degree globally optimized LiDAR system configured or caused to divide a sweep of a surrounding scene. After dividing the scene into wedges, AV 102 aggregates a plurality of LiDAR detections of a geographic area surrounding the 360 degree globally optimized LiDAR system for use in autonomy applications such as, but not limited to, perception and autonomous vehicle control.

Returning to FIG. 4, at step 404, process 400 may include generating, based on a local context in the detection of the active wedge, a conditionally connected track in the one or more prior connected tracks. In some non-limiting embodiments or aspects, for example, AV 102 (e.g., on-board computing device 112, one or more processors of on-board computing device 112) generates, based on a local context in the detection of the active wedge, a conditionally connected track in the one or more prior connected tracks.

In some non-limiting embodiments or aspects, AV 102 obtains a detection of the active wedge in the scene of the environment surrounding the autonomous vehicle. For example, obtaining the detection of the active wedge comprises accumulating point clouds from a partial revolution of the active wedge of a rotating LiDAR unit that can be accumulated to form a globalized LiDAR sweep. AV 102 determines conditional components based on the active wedge that can be used for globalizing the one or more detections to form an approximation of the global data association such that operations on the point clouds appear as if they were performed in a full 360 degree sweep.

In some non-limiting embodiments or aspects, a single detection spans two or more wedges. In such an example, AV 102 can determine the sweep time of validity (e.g., based on a time for completion of a full sweep, an aggregation of each time of validity for each wedge, etc.) before of the corresponding detection messages, such that data association pre-processing can occur while waiting for new detections to generate, at which time, AV 102 can begin processing the active wedge.

In some non-limiting embodiments or aspects, AV 102 waits for a time of validity. In such an example, AV 102 generates, after an active wedge arrives, a conditionally connected component which includes at least one of a conditionally connected edge to add or a previously connected edge to prune.

In some examples, AV 102 determines the conditionally connected edge to add and connects it with one or more tracks (e.g., forms a connection by identifying where a connected edge belongs, etc.). The connected edge shares a common object detection within a respective data association gate. In some examples, AV 102 determines the previously connected edge to prune. For example, AV 102 removes all edges connecting to a track (e.g., each track in the active wedge, etc.) that is located within the active wedge of the scene and does not include any detections from the active wedge within its data association gate.

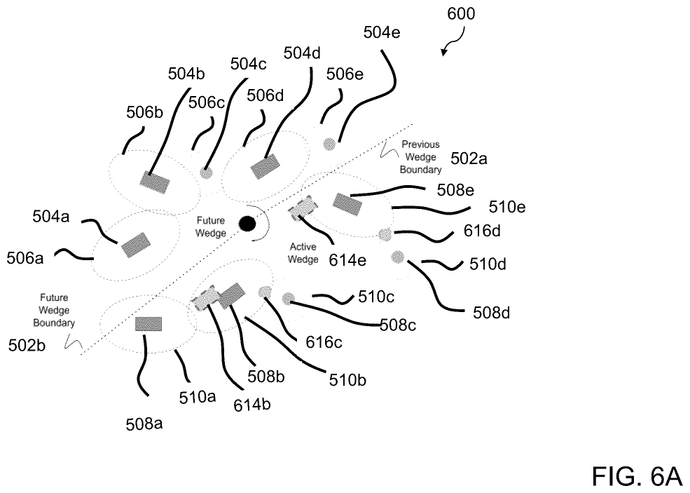

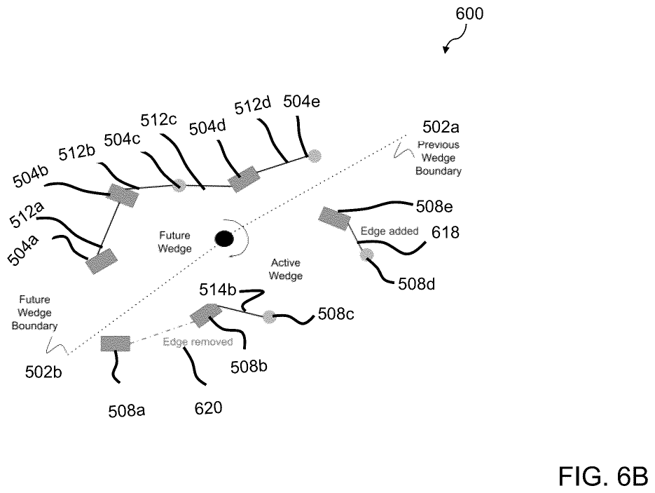

With continuing reference to FIG. 4 and also referencing FIG. 6A, an exemplary illustration includes a global data association scene for dividing a sweep into two LiDAR wedges along wedge boundaries 502a and 502b as in FIG. 5A, which shows current detections received for the active wedge. For example, while forecasting the prior connected components graph (shown in FIGS. 5A and 5B), sensor system 110 of AV 102 obtains a detection message for the active wedge, which includes detections of vehicle tracks 614b, 614e and pedestrian tracks 616c, 616d. As shown in FIG. 6B, estimated tracks 508b-508e, can now be confirmed by updated detections showing objects, such as vehicle tracks 614b, 614e, and pedestrian tracks 616c, 616d (shown in FIG. 6A), which represent the updated location in the active wedge portion of the environment (or scene) surrounding AV 102.

With further reference to FIG. 6B, an exemplary illustration includes an updated connected components graph, based on the newly obtained detections in the active wedge of vehicle tracks 614b, 614e, and pedestrian tracks 616c, 616d of FIG. 6A. For example, added edge 618 denotes an edge (e.g. a conditionally connected edge) added to the graph edge (e.g., AV 102 adds edges to the prior connected components graph between tracks that are bridged by a detection). Thus, edge 618 is added to conditionally connect tracks based on the detections reported in the active wedge message (i.e., 614e and 616d of FIG. 6A), since each forecast tracks 508e and 508d each shares a corresponding common detection, detection 614e and detection 616d of FIG. 6A (e.g., within their associated gates or respective gates, etc.). In another example, broken graph edge 620 denoted by a dashed edge, is an edge that is removed (e.g., AV 102 prunes edges from the prior connected components graph according to a subtraction rule) since track 508a does not have any new detections from the active wedge within its individual data association gate. In addition, previous edge 514b has been confirmed based on the new detections of 614b and 616c in FIG. 6A.

In some non-limiting embodiments or aspects, each conditional connected component (e.g., 508d and 508e of FIG. 6B) is, by definition, mutually independent given the active wedge detections. Therefore, further runtime benefit can be realized (without degrading optimality and efficiency) by further factoring the full active wedge data association problem into N independent scenes, one for each conditional connected component. In this case, not only will this have the same complexity benefit as above, but these scenes can be solved in parallel for further runtime/latency benefit.

In some non-limiting embodiments or aspects, more aggressive edge removal rules (i.e. pairwise data association constraints, and/or the like) can be used to yield additional efficiency and optimality benefits).

Again with reference to FIG. 4, at step 406, process 400 may include generating, a region of influence comprising connected tracks, wherein each connected track constituent includes a track within a union of one or more data association gates of each other connected tracks. In some non-limiting embodiments or aspects, for example, AV 102 (e.g., on-board computing device 112, one or more processors of on-board computing device 112) generates, a region of influence comprising connected tracks and each connected track constituent includes a track within a union of one or more data association gates of each of the other connected tracks.

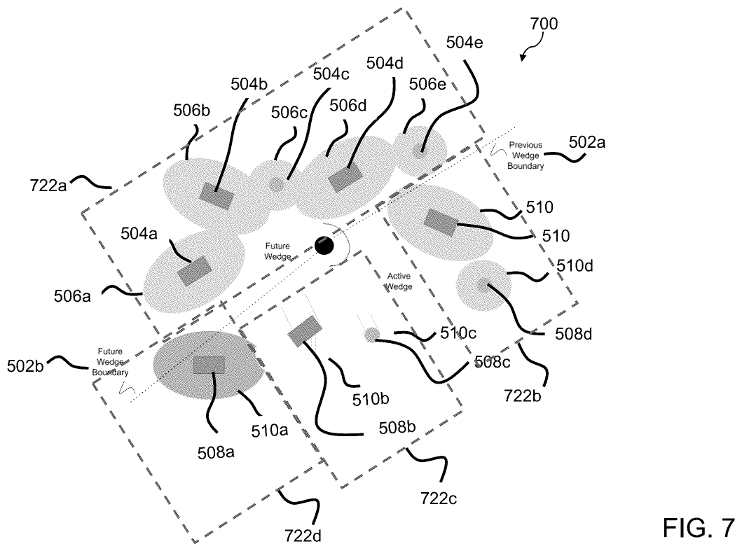

With reference to FIG. 4 and also referencing FIG. 7, an exemplary illustration includes regions of influence 722a-722d corresponding to the connected components illustrated in FIG. 6B showing the active wedge and previous wedge. As shown, each detection from the active wedge that is located in the region of interest 722b or region of interest 722c, or outside of all regions of interest 722a-722d and not intersecting the future wedge boundary can be confidently reported to registration and stored as confident associations immediately. For example, each complete detection from the active wedge that falls inside a region of influence located entirely within the previous or active wedges can be marked as confidently associated and reported downstream in the autonomy stack (i.e., to registration). Accordingly, detections of the active wedge confirmed to be tracks 614b, 614e, 616c, and 616d of FIG. 6A are reported downstream immediately as confident associations. In some non-limiting embodiments, detections from the previous wedge that do not intersect the future wedge are reported downstream as confidently associated. Each of the other detections remain uncertain associations and must wait for detections from the future wedge (which will become the active wedge) to gain a sufficient level of local context and guarantee a globally optimal assignment. For example, track 508a overlaps the future wedge and will be marked as having uncertain associations and must wait for the future wedge detection to gain a sufficient level of context.

In some non-limiting embodiments or aspects, each connected track constituent within the region of influence can impact an assignment of detections to each other object within the region of influence and each track falling outside of the region of influence cannot influence an assignment with respect to any track in the region of influence.

As shown in FIG. 4, at step 408, process 400 may include globalizing the scene over the active wedge and the previous wedge by assigning a confidence level to one or more detections in a localized approximation of a full optimal data association. In some non-limiting embodiments or aspects, for example, AV 102 (e.g., on-board computing device 112, one or more processors of on-board computing device 112) globalizes the scene over the active wedge and the previous wedge by assigning a confidence level to one or more detections in a localized approximation of a full optimal data association.

A confidence level for assigning to one or more detections in a localized approximation may be based on a threshold. For example, assigning a confidence level when a detection is within a threshold of a previously detected track. In another example, a confidence level is based on associations between tracks (e.g., if two tracks are connected together along an edge, an outside track cannot influence the connected tracks). The system would be more confident that the other track was improper, possibly an anomaly, a new recorded track, a poor detection. A track can have a positive or negative influence on the confidence level.

Further, AV 102 matches detections to produce confidence in a track, levels can be used to deduce information from detections that are matching to existing tracks which include at least one of a track that is previously assigned (e.g., a track that belongs to a region of influence that lies entirely inside the active wedge, a track that is split between the active wedge and the previous wedge, etc.), a track that is previously uncertain (e.g., a track that belongs to a future wedge but includes a data association gate extending into the active wedge, a track with a data association gate in a future wedge and an active wedge, etc.), a track that is previously unassigned, a known error track, or a new track. Such logic can be used to make deductions, or combined with other logic disclosed herein to make deductions which can control the threshold in AV 102, to cause a process that allows for the quick and easy identification of conclusions about what tracks are located in the active and the previous wedge (e.g., by using a confidence threshold), one or more given premises can be used to make a conclusion about associating a track. Further, once a track is associated, the associations of the track may be used to form assignments, or alternatively, to influence an assignment within an active wedge. AV 102 is configured to make conclusions based on a region of influence, which includes such associations in the mode that a connection is formed, between tracks that may become an influencer later, the assignment of tracks to a confidence level can be true or false, or some other way to make decisions.

AV 102 not only estimates the velocity, but also estimates uncertainty and some characterization of how much error is expected.

In some non-limiting embodiments, AV 102 generates data association gates. For example, AV 102 generates data association that takes the uncertainty value and views anything that is more than three standard deviations of error, and/or the like, from an expectation, such as where it to be should be, is ruled out. A data association gate eliminates unnecessary uncertainty. As an example, it does not make sense to compare a track one hundred meters behind and/or one hundred meters in front of a moving vehicle (i.e., occurrences or objects within a few feet of AV 102 are more important).

In some non-limiting embodiments, a confidence level may be based on condition of a detection. A confidence level may be based on whether each detection includes factors, such as: a detection that lies entirely within the active wedge, a detection that starts in the previous wedge and extends across a boundary into the active wedge, a track completed in the active wedge which starts in the active wedge, or a track which extends beyond a boundary of the active wedge into a future wedge. In some examples, such factors can be an impact (e.g., a positive or negative influence) on the confidence threshold.

AV 102 may use a global optimal data matching routine, such as the Hungarian algorithm or the Quick Match algorithm, so that the matching is performed to match each available detection with each track that lacks a confident assignment from the previous wedge, and the detections include each active wedge detection and each previous wedge detection with uncertain associations (i.e., none of these tracks receive a confident assignment from the previous wedge), and each track that belongs to a region of influence that lies entirely inside the active wedge, is split between the active wedge and the previous wedge, or is forecasted to lie in a future wedge and includes a gate extending across a future wedge boundary into the active wedge.

AV 102 performs matching that can be used with tracks to match with detections formed in the local context of the region of influence (e.g., detections formed in an active wedge, detection from a previous wedge, detections that fall inside a region of influence located entirely within a previous or active wedge, etc.), tracks outside any region of influence, or tracks crossing into a future wedge. Matching can be through the Quick Match algorithm, a density based clustering algorithm that begins by calculating the Euclidean distance between all features (e.g., tracks, detections, etc.). Still other matching is made through the Hungarian method, a combinatorial optimization algorithm that solves the assignment problem in polynomial time and which anticipate later primal— dual methods.

In some non-limiting embodiments or aspects, AV 102 generates each complete detection from the active wedge or the previous wedge that falls inside a region of influence located entirely within the a wedge, those either of a previous or an active wedge, or complete detections, those that do not intersect the future wedge boundary, those located outside of all regions of influence that can be confidently unassigned, those that can be marked as confidently associated, or reported downstream immediately, wherein each remaining detection can be marked as having uncertain associations, and queued to wait for a future wedge to gain a sufficient level of context.

In some non-limiting embodiments or aspects, AV 102 globalizes one or more detections by matching detections to existing tracks which include at least one of a track that is previously assigned, a track that is previously uncertain, a track that is previously unassigned, or a new track. Matching detections to objects globalizes a local association of objects that are detected in the active wedge or the previous wedge for a period of time of the scene.

In some non-limiting embodiments or aspects, full detections are transmitted down the autonomy stack for registration in the system. For example, only full detections must be reported downstream to registration. AV 102 is configured to operate using a globally optimal data association result for operations, despite and while operating on LiDAR wedges. In such an example, AV 102 globalizes the one or more detections and generates an approximation of the data association result as if operations were performed on a full 360 degree sweep. Tracking latency is reduced by eliminating waiting for and processing of full 360 degree sweeps.

In some non-limiting embodiments or aspects, after determining a globally optimized data association, AV 102 updates, based at least in part on the local track store, a spatial map to include one or more local tracks in a geographical area. In some non-limiting embodiments, the spatial map comprises one or more local tracks previously detected and associated with previous sensor data representing an earlier view of the scene, and the earlier view is updated as a function of time and distance.

AV 102, while traversing a route, may determine a trajectory to avoid an object within a path of the autonomous vehicle based at least in part on the globalized data (e.g., globally optimized association data), such as globalized data stored locally by on-board computing device 112 in an on-board database or stored as a spatial map of the geographical area.

AV 102, while traversing a route, may determine a trajectory by matching detections to existing tracks to globalize a local association of tracks detected in the active wedge or the previous wedge for a time period of the scene. AV 102, while traversing a route, determines a trajectory with the confidence level defined by associations of the one or more detections.

AV 102, while traversing a route, determines a trajectory by globalizing the one or more detections causing the localized approximation of the full optimal data association with a result as if operations on the point clouds were performed on a full 360 degree sweep.

FIG. 8 illustrates a diagram of an exemplary computer system 800 in which various devices, systems, and/or methods, described herein, may be implemented. Computer system 800 can be any computer capable of performing the functions described herein.

Computer system 800 includes one or more processors (also called central processing units, or CPUs), such as processor 804. Processor 804 is connected to a communication infrastructure 806 (or bus).

One or more processors 804 may each be a graphics processing unit (GPU). In an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, and/or the like.

Computer system 800 also includes user input/output device(s) 803, such as monitors, keyboards, pointing devices, etc., that communicate with communication infrastructure 806 through user input/output interface(s) 802.

Computer system 800 also includes a main memory (or primary memory) 808, such as random access memory (RAM). Main memory 808 may include one or more levels of cache. Main memory 808 has stored therein control logic (i.e., computer software) and/or data.

Computer system 800 may also include one or more secondary storage devices or secondary memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/or any other computer data storage device. Removable storage drive 814 reads from and/or writes to removable storage unit 818 in a well-known manner.

According to an exemplary embodiment, secondary memory 810 may include other means, instrumentalities, or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 800 may further include a communication or network interface 824. Communications interface 824 enables computer system 800 to communicate and interact with any combination of remote devices, remote networks, remote entities, etc. (individually and collectively referenced by remote device(s), network(s), or entity(s) 828). For example, communications interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

In an embodiment, a tangible, non-transitory apparatus or article of manufacture comprising a tangible, non-transitory computer useable or readable medium having control logic (software) stored thereon is also referred to herein as a computer program product or program storage device. This includes, but is not limited to, computer system 800, main memory 808, secondary memory 810, and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 8. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
determining, by one or more processors while detecting an active wedge in a scene of an environment surrounding an autonomous vehicle, one or more prior connected tracks in the scene based on a detection of a previous wedge in the scene;
generating, by the one or more processors based on a local context in the detection of the active wedge, a conditionally connected track in the one or more prior connected tracks;
generating, by the one or more processors, at least one region of influence comprising the conditionally connected track, wherein the at least one region of influence forms a union of the conditionally connected track and at least one of the one or more prior connected tracks; and
globalizing, by the one or more processors, the scene over the active wedge and the previous wedge by assigning a confidence level to one or more detections in a localized approximation of a full optimal data association.

2. The computer-implemented method of claim 1, further comprising:
obtaining the detection of the active wedge including point clouds from a partial revolution that are generated in each of the previous wedge and the active wedge by a rotating light detection and ranging (LiDAR) unit and accumulating the previous wedge and the active wedge to form a globalized LiDAR sweep.

3. The computer-implemented method of claim 2, wherein the detection includes at least one of: a detection that lies entirely within the active wedge, a detection that starts in the previous wedge and extends across a boundary into the active wedge, a track completed in the active wedge which starts in the active wedge, or a track which extends beyond a boundary of the active wedge into a future wedge.

4. The computer-implemented method of claim 3, wherein globalizing the scene over the active wedge and the previous wedge, comprises:
matching the detection to one or more existing tracks which include at least one of a track that is previously assigned, a track that is previously uncertain, a track that is previously unassigned, or a new track, wherein:
matching the detection to one or more existing tracks globalizes a local association of a track detected in the active wedge or the previous wedge for at least a time period of the scene;
the confidence level is defined by associating one or more detections of the detection that match with tracks formed in the local context of the region of influence, tracks outside each region of influence, or tracks crossing into the future wedge; and
globalizing the scene over the active wedge and the previous wedge causes the localized approximation of the full optimal data association with a result as if operations on the point clouds were performed on a full 360 degree sweep.

5. The computer-implemented method of claim 1, wherein determining the one or more prior connected tracks, comprises:
forecasting each track in the scene based on one or more previous detections up to a time of validity based on the active wedge; and
generating a union of forecasted tracks that comprises a pairwise connection between one or more forecasted tracks, each pairwise connection determined to be within a pairwise threshold generated from a Euclidian distance of each data association gate for each of the forecasted tracks.

6. The computer-implemented method of claim 1, further comprising:
determining a previously connected edge to prune by removing all edges connecting to each track that is located within the active wedge of the scene that does not include any detections from the active wedge within a data association gate.

7. The computer-implemented method of claim 6, wherein generating a conditionally connected track in the one or more prior connected tracks further comprises:
determining a conditionally connected edge to add by connecting one or more tracks that share a common object detection within respective data association gates.

8. The computer-implemented method of claim 1, wherein the at least one region of influence forms a union between one or more data association gates of the conditionally connected track and at least one of the one or more prior connected tracks, and each connected track of the one or more prior connected tracks located within the region of influence can impact an assignment within the region of influence, and each track located outside of the region of influence cannot influence an assignment within the region of influence.

9. The computer-implemented method of claim 1, wherein detections spanning more than one wedge are provided or associated with a globally unique identifier (GUID), such that correspondence between partial detections across multiple wedges is traceable.

10. A computing system, comprising:
one or more processors; and
one or more computer-readable medium storing instructions that, when executed by the one or more processors, cause the computing system to perform operations, the operations comprising:
determining, while detecting an active wedge in a scene of an environment surrounding an autonomous vehicle, one or more prior connected tracks in the scene based on a detection of a previous wedge in the scene;
generating, based on a local context in the detection of the active wedge, a conditionally connected track in the one or more prior connected tracks;
generating at least one region of influence comprising the conditionally connected track, wherein the at least one region of influence forms a union of the conditionally connected track and at least one of the one or more prior connected tracks; and
globalizing the scene over the active wedge and the previous wedge by assigning a confidence level to one or more detections in a localized approximation of a full optimal data association.

11. The computing system of claim 10, wherein the operations further comprise:
obtaining the detection of the active wedge including point clouds from a partial revolution that are generated in each of the previous wedge and the active wedge by a rotating light detection and ranging (LiDAR) unit and accumulating the previous wedge and the active wedge to form a globalized LiDAR sweep.

12. The computing system of claim 11, wherein the detection includes at least one of: a detection that lies entirely within the active wedge, a detection that starts in the previous wedge and extends across a boundary into the active wedge, a track completed in the active wedge which starts in the active wedge, or a track which extends beyond a boundary of the active wedge into a future wedge.

13. The computing system of claim 10, wherein globalizing the scene over the active wedge and the previous wedge further comprises:
matching the detection to one or more existing tracks which include at least one of a track that is previously assigned, a track that is previously uncertain, a track that is previously unassigned, or a new track, wherein:
matching the detection to the one or more existing tracks globalizes a local association of a track detected in the active wedge or the previous wedge for at least a time period of the scene;
the confidence level is defined by associating one or more detections of the detection that match with tracks formed in the local context of the region of influence, tracks outside each region of influence, or tracks crossing into the future wedge; and
globalizing the scene over the active wedge and the previous wedge causes the localized approximation of the full optimal data association with a result as if operations on the point clouds were performed on a full 360 degree sweep.

14. The computing system of claim 10, wherein determining the one or more prior connected tracks further comprises:
forecasting each track in the scene based on one or more previous detections up to a time of validity based on the active wedge; and
generating a union of forecasted tracks that comprises a pairwise connection between one or more forecasted tracks, each pairwise connection determined to be within a pairwise threshold generated from a Euclidian distance of each data association gate for each of the forecasted tracks.

15. The computing system of claim 10, wherein the operations further comprise:
determining a previously connected edge to prune by removing all edges connecting to each track that is located within the active wedge of the scene which does not include any detections from the active wedge within a data association gate.

16. The computing system of claim 15, wherein determining the conditionally connected track in the one or more prior connected tracks further comprises:
determining a conditionally connected edge to add by connecting one or more tracks that share a common object detection within respective data association gates.

17. The computing system of claim 10, wherein the at least one region of influence forms a union between one or more data association gates of the conditionally connected track and at least one of the one or more prior connected tracks, and each connected track of the one or more prior connected tracks located within the region of influence can impact an assignment within the region of influence, and each track located outside of the region of influence cannot influence an assignment within the region of influence.

18. The computing system of claim 10, wherein detections spanning more than one wedge are provided or associated with a globally unique identifier (GUID), such that correspondence between partial detections across multiple wedges is traceable.

19. A non-transitory computer-readable medium having instructions stored thereon that, when executed by at least one computing device, cause the at least one computing device to perform operations comprising:
determining, while detecting an active wedge in a scene of an environment surrounding an autonomous vehicle, one or more prior connected tracks in the scene based on a detection of a previous wedge in the scene;
generating, based on a local context in the detection of the active wedge, a conditionally connected track in the one or more prior connected tracks;
generating at least one region of influence comprising the conditionally connected track, wherein the at least one region of influence forms a union of the conditionally connected track and at least one of the one or more prior connected tracks; and
globalizing the scene over the active wedge and the previous wedge by assigning a confidence level to one or more detections in a localized approximation of a full optimal data association.

20. The non-transitory computer-readable medium of claim 19, wherein the operations further comprise:
matching the detection to one or more existing tracks which include at least one of a track that is previously assigned, a track that is previously uncertain, a track that is previously unassigned, or a new track, wherein:
matching the detection to one or more existing tracks globalizes a local association of a track detected in the active wedge or the previous wedge for at least a time period of the scene;
the confidence level is defined by associating one or more detections of the detection that match with tracks formed in the local context of the region of influence, tracks outside each region of influence, or tracks crossing into a future wedge; and
globalizing the scene over the active wedge and the previous wedge causes the localized approximation of the full optimal data association with a result as if operations on the point clouds were performed on a full 360 degree sweep.
